(19) United States
(12) Patent Application Publication
(10) Pub. No.: US 2008/0105092 A1
(43) Pub. Date: May 8, 2008

(54) Bit for removing damaged screws

(76) Inventor: Bo Shen CHEN, Taichung County (TW)

Correspondence Address: Dr. BANGER SHIA;Int''l Patent Office of Bang Shia, 102 Lindencrest Ct, Sugar Land, TX, 77479-5201, US

(21) Appl. No.: 11/556,688

(22) Filed: Nov. 4, 2006

(51) Int. Cl. B25B 13/50

(52) U.S. Cl. 81/53.2

(57) ABSTRACT

A bit for removing damaged screws is provided with a plurality of scraping grooves formed on the relief surface and wind around the axis of the bit. The scraping grooves allow the scraping edge to work as a non-planar scraping edge with concaves and convexes (increasing the scraping area and producing a plurality of sharp protrusions), which makes it easier for the bit to engage in the slot of a damaged screw and to get a good purchase and leverage on the damaged screw for removing a damaged screw easily. The scraping grooves also allow the front end of the bit to produce different working diameters that permits the bit to be engaged in the slot of differently sized screws.

### BACKGROUND OF THE INVENTION

1. Field of the Invention

The present invention relates to a bit, and more particularly to a bit for removing damaged screws.

2. Description of the Prior Art

Screw products (such as wood screws, concrete screws, and special screws) are used in various applications of industries. Maintaining a substantial life cycle of screws therefore becomes an urgent concern. Screws are often damaged due to inappropriate operations. Factors such as uneven rotating force applied to the screws by a user's hand, inaccurate contacting angle between the screwdriver and the screw, or a broken tip head of a screwdriver, etc. will all shorten a screw's life, adversely effecting the work associated with fastening or loosing screws.

Referring to FIGS. 1 and 2, U.S. Pat. No. 6,595,730 discloses a bit for removing damaged screws, the bit 10 has an hexagonal end which is to be held in a chuck of an electric tool, and another tip end of the bit 10 is formed with two recesses 11. Each of the recesses is defined by a scraping surface 12 and a boundary surface 13, the scraping surface 12 has a scraping edge 121, and the boundary surface 13 has a boundary edge 131. A conical relief surface 14 is defined between the scraping edges 121, 131. As shown in FIG. 3, the scraping edges 121, 131 of the bit 10 engage the slot or cross recess 21 of the damaged screw 20 and have a purchase and leverage on the head of the damaged screw 20 to break it away from its firm engagement with the object (not shown) and put it into rotation with the bit and back it out. In actual operation, there is still room for improving this conventional bit, based on the following two reasons:

(1) After engaging in the slot 21 or the cross recess 21 of the damaged screw 20, the first revolution of the scraping edge 121, which is a linear edge, will scrape the surface of the slot or the cross recess 21 smooth (the scraping angle is determined by the scraping edge 121). If slip occurs during the first revolution of the scraping edge 121, the scraping edge 121 will lose the effective point of action, thus weakening the engaging force of the scraping edge 121, 131 acted on the damaged screw 20, and as a result, the leverage on the damaged screw 20 is less effective.

(2) In reference to FIG. 3, in operation of a screw, either the slot 21 of the screw 20 can be completely damaged or the superficial portion of the slot 21 can be damaged. If it is the slot 21 that is completely damaged, the slot 21 will be turned into a downward rounded surface. On the other hand, if it is the superficial portion of the slot 21 that is damaged (the deep of the slot 21 is still in the shape of a slot), the scraping edge 121 will be engaged in a line-to-line fashion with the slot 21. If the angle of the scraping edge 21 of the conventional bit 10 is similar to the damaged of the slot 21 of the screw 20, it is very likely that a slip will occur and the leverage on the damage screw is less effective; as a result, the screw 20 cannot be removed.

The present invention has arisen to mitigate and/or obviate the afore-described disadvantages.

### SUMMARY OF THE INVENTION

The primary objective of the present invention is to provide a bit capable of fitting in the slot of differently sized screws. A plurality of scraping grooves are formed on the relief surface and are located along the scraping edge of the bit. The scraping grooves allow the front end of the bit to produce different working diameters so that the bit can be engaged in the slot of screws with various sizes.

Another objective of the present invention is to provide a bit for removing damaged screws. A plurality of scraping grooves are formed in the relief surface and wind around the axis of the bit. The scraping grooves allow the scraping edge to become a non-planar scraping edge with concaves and convexes (increasing the scraping area and producing a plurality of sharp protrusions), which makes it easier for the bit to engage in the slot of the damaged screw and to get a good purchase and leverage on the damaged screw for the damaged screw to be easily removed.

Yet another objective of the present invention is to provide a bit for removing damaged screws and to prevent the bit from slipping. The scraping grooves are used to scrape out uneven surfaces when the scraping edge works for the next scraping edge on the same surface to be engaged with the bit firmly. Therefore, the bit of the present invention is less likely to slip off, and hence it would be more efficient to remove a damaged screw.

### BRIEF DESCRIPTION OF THE DRAWINGS

FIG. 1 is a perspective view of a conventional bit;

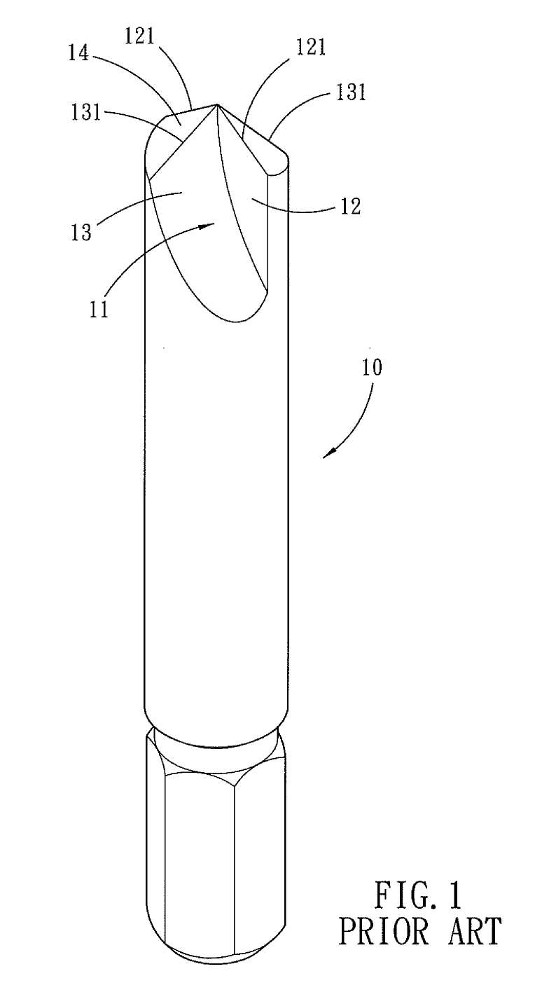

FIG. 2 is top view of a conventional bit;

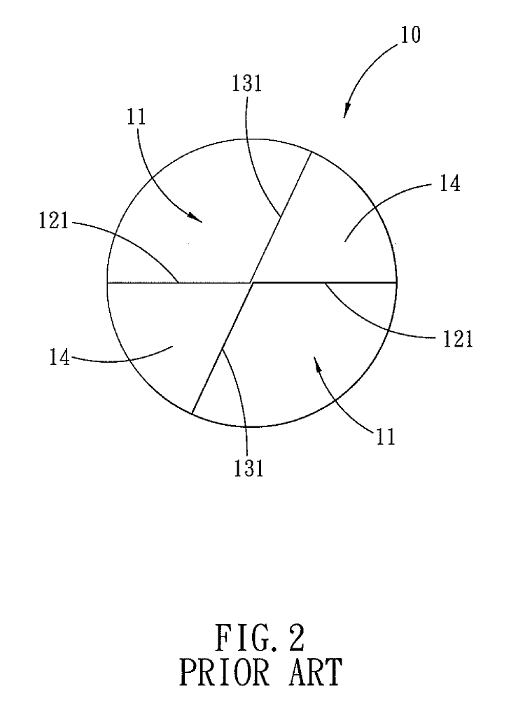

FIG. 3 is an operational view of a conventional bit;

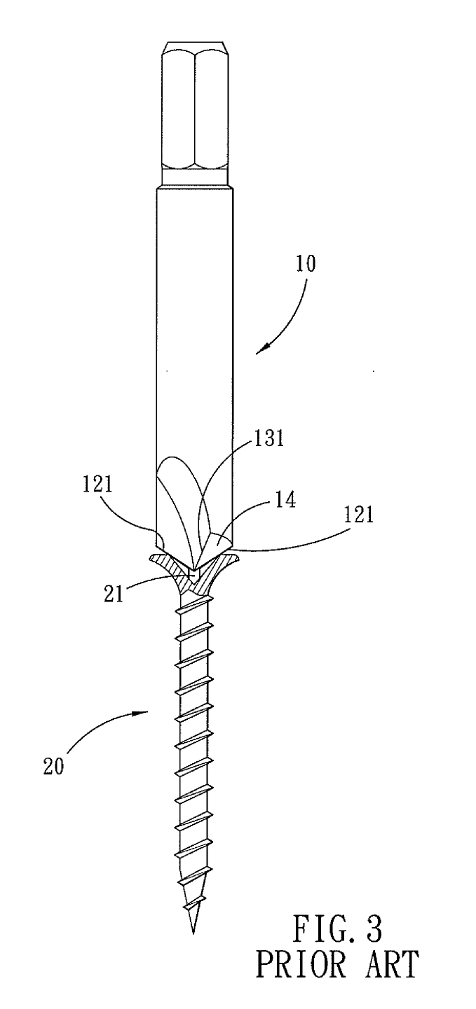

FIG. 4 is a perspective view of a bit for removing damaged screws in accordance with the present invention;

FIG. 5 is a side view of the bit in accordance with the present invention;

FIG. 6 is a top view of the bit in accordance with the present invention;

FIG. 7 is an operational view in accordance with the present invention of showing that the bit is rotating a large screw;

FIG. 8 is a top view of a bit in accordance with another embodiment of the present invention;

FIG. 9 is a top view of a bit in accordance with another embodiment of the present invention;

FIG. 10 shows another type of bit for removing damaged screws in accordance with the present invention; and

FIG. 11 is an operational view in accordance with the present invention of showing that the bit is rotating a small screw.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

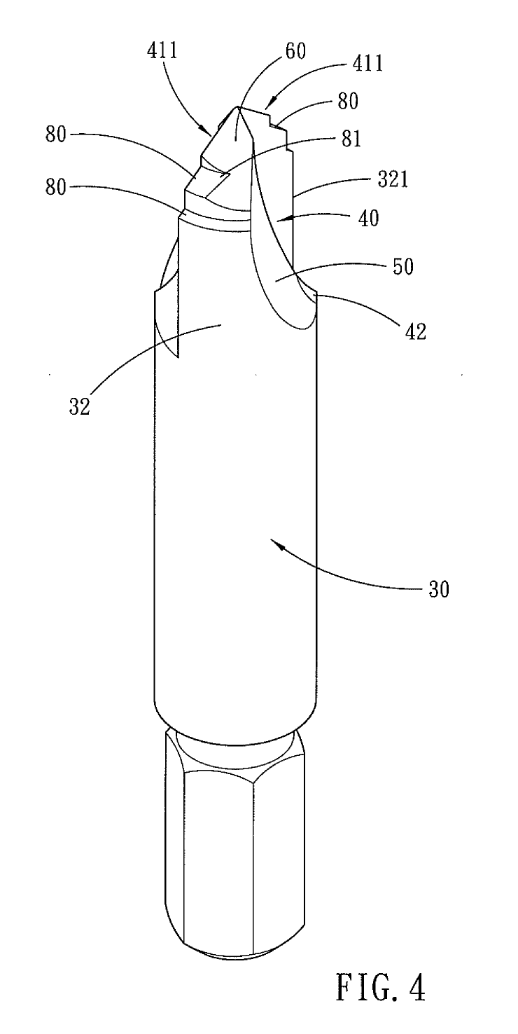

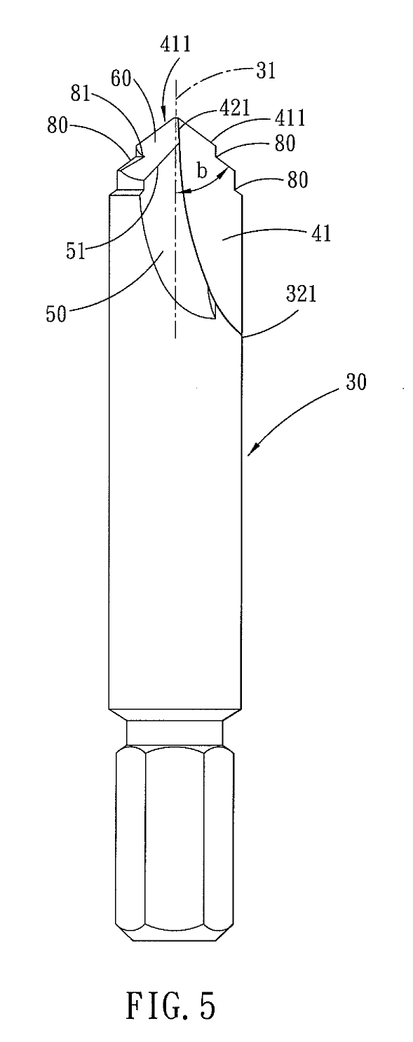

Referring to FIGS. 4 and 5, a bit for removing damaged screws in accordance with the present invention is shown.

The bit 30 is a unitary structure and comprises an axis 31 and a tip 32.

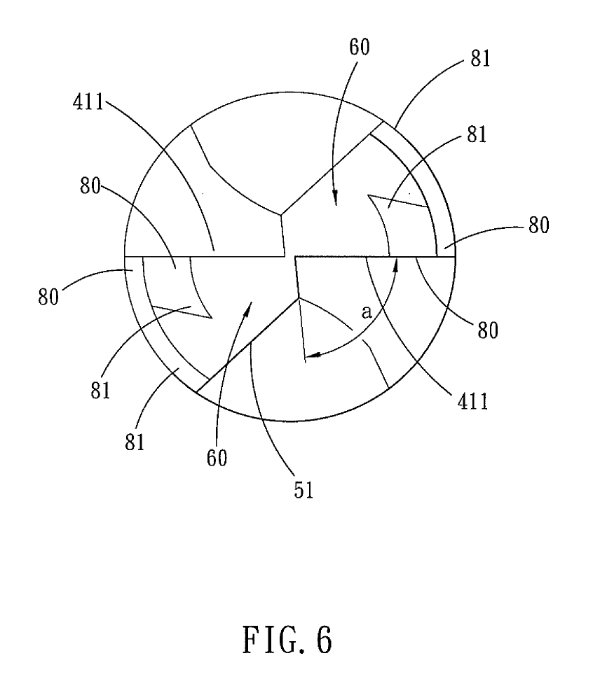

In the periphery 321 of the tip 32 of the bit 30 are formed two longitudinal recesses 40 bounded by on one side a scraping surface 41 facing in the counter-clockwise direction and on the other side by a boundary surface 42 facing in the clockwise direction. An angle between the boundary surface and the scraping surface 41 is 90 degrees (as shown in FIG. 6).

The scraping surface 41 has a scraping edge 411 extending from the periphery 321 of the bit 30 to the axis 31. The scraping edge 411 is made at an angle in a range of 35 to 80 degree, to the axis 31 of the bit 30, as shown in FIG. 5. The boundary 5 surface 42 has a boundary edge 421 which is a straight line from the boundary surface 42 to the axis 31. The respective boundary edges 421 and the respective scraping edges 411 generally form a cross.

Two longitudinal separating surfaces 50 are formed at on the periphery of the tip 32 of the bit 30 and meet the boundary surface 42 at a certain angle. The separating surfaces 50 each has a separating edge 51, so that the separating edges 51, the boundary edges 421, the scraping edges 411 and the periphery 321 of the bit define a relief surface 60 which is generally rectangular-shaped. The angle of the separating edges 51 and the boundary edge 421 to the axis 31 of the bit 30 is less than the angle of the scraping edge 411 to the axis 31 of the bit 30.

The key characteristics of the present invention are described as follows:

A plurality of scraping grooves 80 is formed in the relief surface 60 of the bit 30 and winds around the axis of the bit. The scraping grooves 80 are annularly arranged and have different diameters. The front end of the respective scraping grooves 80 is located at the top of the scraping edge 411 of the scraping surface 41, and each of the scraping grooves 80 winds around the axis 31 of the bit 30 and extends to form an arc-shaped chip-discharging groove 81. The arc-shaped chip-discharging grooves 81 in the relief surface 60 can make the bit 30 produce different working diameters D1, D2 and D3, and the scraping grooves 80 make the scraping edge 411 become a non-planar scraping edge with concaves and convexes.

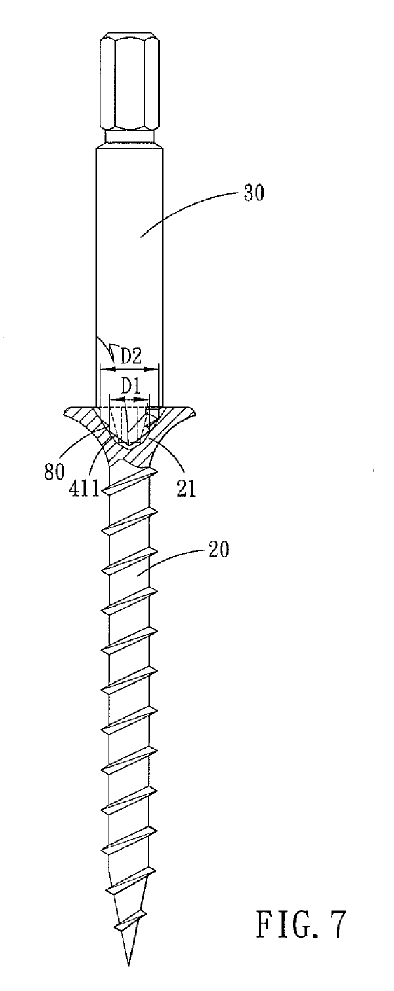

For a better understanding of the present invention, its operation and function, reference should be made to FIG. 7. During the course of removing the damaged screw 20, the scraping edge 411 of a same-sized bit 30 is engaged in the slot 21 of the damaged screw 20. The scraping grooves 80 make the scraping edge 411 become an uneven scraping edge with concaves and convexes, this will not only increase the scraping area but also will produce a plurality of sharp protrusions that can deeply engage in the slot 21 of the damaged screw. At this moment, the force applied by the user will make the scraping edge 411 and the scraping grooves 80 engage (similar to an action of insertion) more deeply in the slot 21 of the damaged screw 20, meanwhile, the concaves and convexes of the scraping edge 411 will be engaged with the surface of the slot 21 of the damaged screw 20, and chips will be discharged through the chip-discharging groove 81 of the scraping grooves 80, so as to get a good purchase and leverage on the damaged screw 20 to remove it easily.

On the other hand, during the first revolution, the scraping grooves 80 will scrape out an uneven surface. If the bit is unable to firmly engage with and rotate the screw 20 during the first revolution. Then in the second revolution, the scraping grooves 80 will alternatively scrape the previously formed uneven surface, so that the next scraping edge on the same surface can be engaged with the bit more firmly. Therefore, the bit of the present invention is less likely to slip, and it is easier to remove the damaged screw.

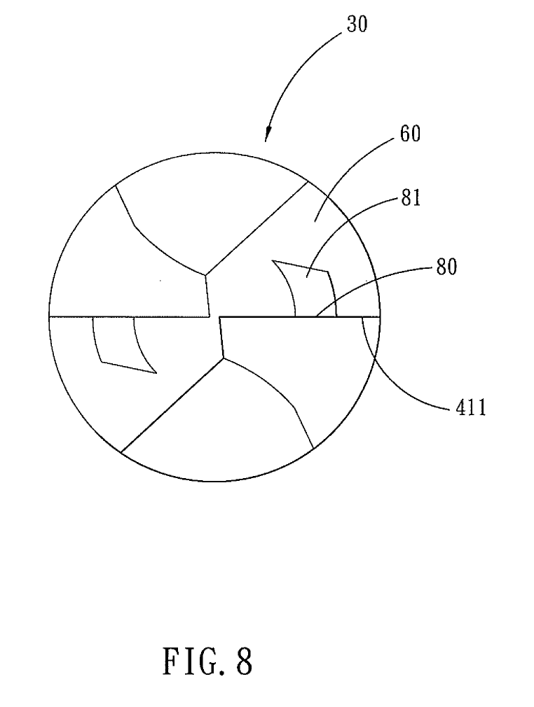

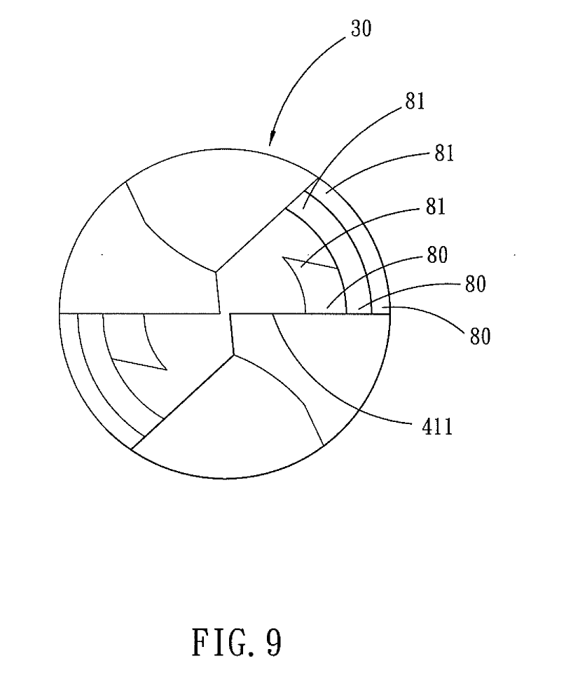

It is to be noted that, as shown in FIGS. 8 and 9, the scraping grooves 80 are formed in the relief surface 60 of the bit 30, and one, two, three or a plurality of scraping groove all can produce a predetermined effect. Therefore, FIGS. 8 and 9 disclose the embodiments of the bits with one scraping groove 80 and with three scraping grooves 80, and other number of the scraping grooves not disclosed in the drawing is also considered to be within the scope of the present invention.

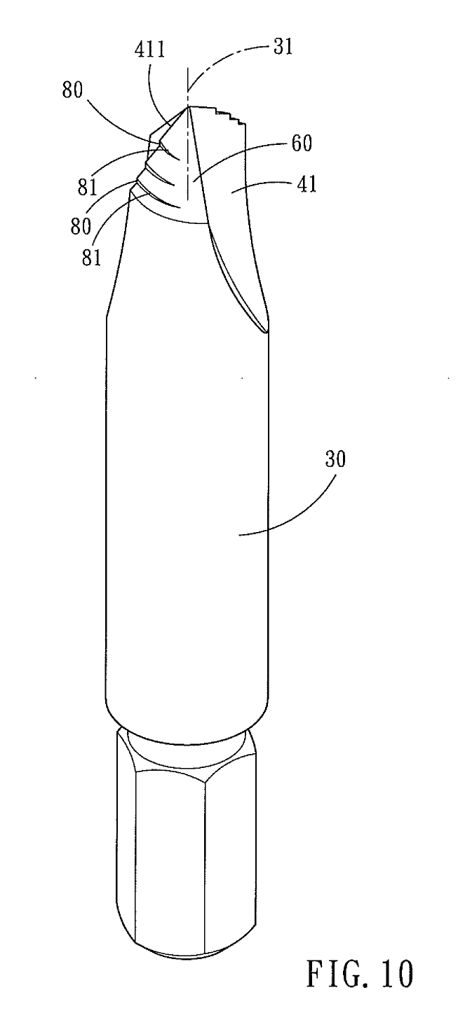

Referring to FIG. 10, the scraping grooves 80 in accordance with the present invention can be formed in the scraping surfaces of different types of bits. The bit 30 shown in FIG. 10 is an ordinary bit 30. The scraping grooves 80 are also formed in the relief surface 60 of the bit 30 and wind around the axis thereof. The scraping grooves 80 are annularly arranged and have different diameters. The front end of the respective scraping grooves 80 is located at the top of the scraping edge 411 of the scraping surface 41, and each of the scraping grooves 80 winds around the axis 31 of the bit 30 and extends to form an arc-shaped chip-discharging groove 81. By using the aforementioned design, the scraping grooves 80 make the scraping edge 411 become a non-planar scraping edge with concaves and convexes.

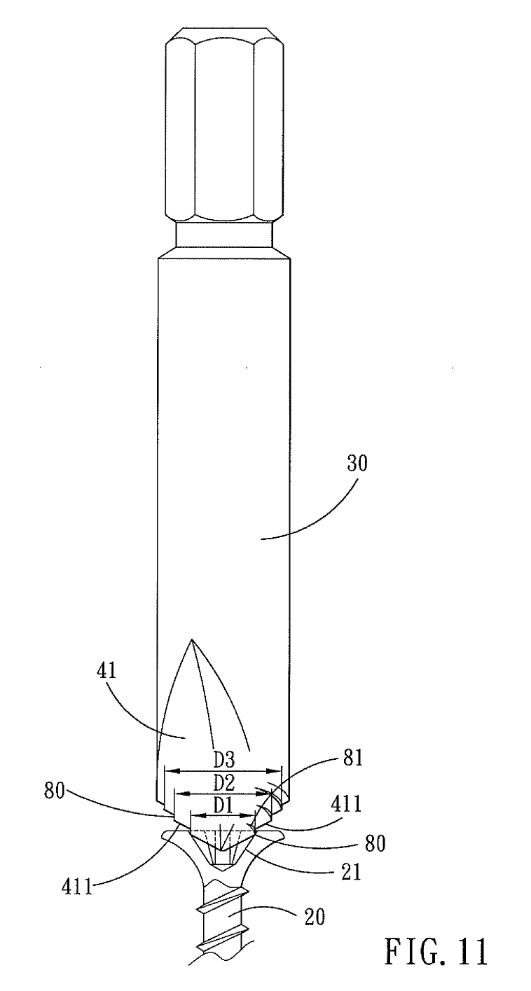

Referring to FIG. 11, since the front end of the respective scraping grooves 80 is located at the top of the scraping edge 411 of the scraping surface 41, and each of the scraping grooves 80 winds around the axis 31 of the bit 30 and extends to form an arc-shaped chip-discharging groove 81, the bit 30 will produce different working diameters D1, D2 and D3. The small working diameter D1 permits the bit 30 to be engaged in the slot of a small screw. As for the method of removing a large screw, please refer to FIGS. 7.

To summarize, a bit for removing damaged screws in accordance with the present invention is provided with a plurality of scraping grooves formed in the relief surface and located along the scraping edge of the bit. The scraping grooves are generally located in the direction of the axis of the bit and are used to scrape out uneven surfaces each time the scraping edge works. Therefore, the bit of the present invention can get a good purchase and leverage on the damaged screw and is less likely to slip, and it is easier to remove the damaged screw.

While we have shown and described various embodiments in accordance with the present invention, it is clear to those skilled in the art that further embodiments may be made without departing from the scope of the present invention.

1. A bit for removing damaged screws comprising: scraping surfaces facing in a counterclockwise direction formed on a top of the bit, a scraping edge formed in a top edge of the respective
scraping surfaces, the scraping edge and a periphery of the bit define a relief surface; wherein
scraping grooves are formed in the relief surface and wind around an axis of the bit, and a front end of the respective scraping grooves is located at a top of the scraping edge of the scraping surfaces;
wherein the counterclockwise direction is determined by viewing from the top of the bit the scraping grooves are formed in the relief surface and are annularly arranged and have different diameters;
each of the scraping grooves winds around the axis of the bit and extends to form an we-shaped chip-discharging groove;
the re-shaped chip-discharging groove in the relief surface makes a front end of the bit produce different working diameters.

2. (canceled)

3. (canceled)

4. (canceled)

5. (canceled)

6. (canceled)

7. The bit for removing damaged screws as claimed in claim 1, wherein the arc-shaped chip-discharging groove is a chute.

8. (canceled)
